(19) United States
(12) Patent Application Publication
(10) Pub. No.: US 2023/0305129 A1
(43) Pub. Date: Sep. 28, 2023

(54) Object Detection with Confidence Levels Using Compressed Radar Measurements

(71) Applicants: Ramesh Annavajjala, Natick, MA (US); Kuntal Chowdhury, Andover, MA (US)

(72) Inventors: Ramesh Annavajjala, Natick, MA (US); Kuntal Chowdhury, Andover, MA (US)

(21) Appl. No.: 17/703,641

(22) Filed: Mar. 24, 2022

(51) Int. Cl. G01S 13/04

(52) U.S. Cl. CPC G01S 13/04

(57) ABSTRACT

Multi-channel compressed analog-to-digital (ADC) samples along with compressed calibration data received from the radar unit are de-compressed on the centralized signal processing unit prior to calibration compensation and DC-offset removal. Time-domain samples on each antenna channel are processed into range-domain samples and range-Doppler samples using windowing and FFT operations. For each range-domain sample, angle-domain samples are generated by performing windowing and angle-domain FFT operation over antenna channels. Joint object detection is performed separately on de-compressed ADC samples, range-domain samples, range-Doppler samples, or range-angle samples to provide detection metrics and confidence levels for each detected object.

### DETAILED DESCRIPTION OF THE INVENTION

The embodiments of our invention provide methods for detection metrics and confidence level estimation for multiple objects in range, Doppler, and angle domains from compressed ADC radar sample returns.

FIG. 1 shows multi-channel time-domain sample generation including compressed calibration sample buffer 101, compressed ADC sample buffer 102, de-compression operation 103, storing of de-compressed calibration data 104, performing calibration compensation 105, and DC-offset compensation 106 according to the embodiments of our invention.

With NR ADC channels, the number of bits stored in a compressed ADC sample buffer 102 is Nb whereas the number of bits stored in a compressed calibration sample buffer 101 is Ncal. The de-compression operation 103 applied on Nb bits of the compressed ADC sample buffer 102 produces Ns*P complex-valued samples where Ns is the number of samples per pulse and P is the number of pulses. A radar pulse is also referred to as a chirp. The de-compression operation 103 applied on Ncal bits of the compressed calibration sample buffer 101 produces Ns*P complex-valued samples which are stored in 104.

Calibration compensation 105 is an element-wise multiplication operation of the Ns*P de-compressed calibration samples with the Ns*P de-compressed ADC samples. With a two-dimensional array element X[(p−1)*Ns+n, j] denoting the n-th de-compressed ADC sample on p-th pulse, and on antenna channel j, and U[(p−1)*Ns+n, j] denoting the n-th de-compressed calibration sample on p-th pulse, and on antenna channel j, where n=1, 2, . . . , Ns, p=1, 2, . . . , P, and j=1, 2, . . . , NR, then the calibration compensation operation 105 produces Y[(p−1)*Ns+n, j] which is given by Y[(p−1)*Ns+n, j]=X[(p−1)*Ns+n, j]*U[(p−1)*Ns+n, j].

Direct current (DC)-offset compensation operation 106 estimates the DC offset present in each pulse, and then removes this DC offset from every sample of that pulse. The DC offset on pulse p and on antenna channel j is estimated as DcOffset[p, j]=(1/N)*sum(n=1, 2, . . . , Ns){Y[(p−1)*Ns+n, j]}. After the DC-offset compensation, the time-domain sample on antenna channel j is given by Z[(p−1)*Ns+n, j]=Y[(p−1)*Ns+n, j]−DcOffset[p, j].

FIG. 2 shows range-domain sample generation on each antenna path including range window coefficient buffer 201, range window application 102 and range-domain fast-Fourier transform (FFT) operation 203 according to the embodiments of our invention.

With NR antenna channels, the number of time-domain samples on a given pulse on antenna channel j is given by Ns. We denote by X[n, j], n=1, 2 . . . , Ns and j=1, 2, . . . , NR, the time-domain sample n on antenna channel j. On each antenna channel, a window of length Ns is applied by 202 to a vector of Ns samples associated with a given pulse.

The window operation is elementwise. With Window(n) denoting the window coefficient n, n=1, . . . , Ns, the output of 202 is Y[n, j]=Window(n)*X[n, j]. Here, [Window(1), . . . , Window(Ns)] is a coefficient vector that is common to all the pulses and antenna channels and is stored in 201. Example window operations include Hamming, Hanning and Kaiser.

An FFT operation 203 is performed over a vector (Y[1,j],Y[2,j], . . . , Y[Ns,j]) of length Ns for each pulse and on each antenna channel j. The FFT length N can be larger or smaller than Ns, and is configurable by the radar application. If N is smaller than Ns, then only the first N-sample vector (Y[1,j], . . . , Y[N,j]) will be considered for FFT processing. If N is larger than Ns, then N-Ns zeros are added to (Y[1,j], Y[2,j], . . . , Y[Ns,j]) prior to an N-point FFT operation.

FIG. 3 shows range- and Doppler-domain sample generation on each antenna path including Doppler window coefficient buffer 301, Doppler window application 302, static clutter removal 303, and Doppler FFT operation 304 according to the embodiments of our invention.

With NR antenna channels, the number of range samples per pulse on antenna channel j is given by N. With P pulses in one radar frame, range sample n belonging to pulse P on antenna channel j is given by X[(p−1)*N+n, j], where p=1, 2, . . . , P, n=1, 2, . . . , N, and j=1, 2, . . . , NR.

On each antenna channel, a window of length P is applied by 302 to a vector of P samples associated with a given range sample. These P samples on antenna j, and on range sample indexed by n, are X[n, j], X[n+N, j], . . . , X[n+(P−1)*N, j].

The window operation is elementwise. With Window(p) denoting the window coefficient p, p=1, . . . , P, the output of 302 is Y[(p−1)*N+n, j]=Window(p)*X[(p−1)*N+n, j]. Here, [Window(1), . . . , Window(P)] is a coefficient vector that is common to all the range bins and antenna channels and is stored in 301.

On antenna channel j, j=1, 2, . . . , NR, and on range sample n, 303 computes the static clutter as A[n, j]=(1/P)*sum(p=1, 2, . . . , P){Y[(p−1)*N+n, j]}, and is removed from Y[(p−1)*N+n, j] to produce Z[(p−1)*N+n, j] as Z[(p−1)*N+n, j]=Y[(p−1)*N+n, j]−A[n, j].

An FFT operation 304 is performed over a vector (Z[n, j], Z[n+N, j], . . . , Z[n+(P−1)*N, j]) of length P on each range bin n and on each antenna channel j. The FFT length can be larger or smaller than P, and is configurable by the radar application. If the FFT length M is smaller than P, then only the first M-sample vector (Z[n, j], . . . , Z[n+(M−1)*N, j]) will be considered for processing. If M is larger than P, then M-P zeros are added to (Z[n, j], Z[n+N, j], . . . , Z[n+(P−1)*N, j]) prior to an M-point FFT operation.

FIG. 4 shows range- and angle-domain sample generation on each antenna path including sample rearrangement 401, angle window coefficient buffer 402, angle window application 403, and angle FFT operation 404 according to the embodiments of our invention.

With NR antenna channels, the number of range samples on antenna channel j is given by N where N is the number of range bins. With p denoting the range bin index, one complex-valued range-domain sample as input to sample rearrangement block 401 is given by X[p, j]. Block 401 rearranges N*NR samples into N range-domain channels, with NR samples per range-domain channel. One range-domain channel, with range bin index p, has NR samples. On each range-domain channel, a window of length NR coefficients is applied by 403 to a vector of samples of length NR. The window operation is elementwise. With Window(i) denoting the window coefficient i, i=1, . . . , NR, X[p, i] denoting the antenna sample index i on range bin p, the output of 403 is Y[p, i]=Window(i)*X[p, i]. Here, [Window(1), . . . , Window(NR)] is a coefficient vector that is common to all the range bins and is stored in 402.

An FFT operation 404 is performed over a vector (Y[p, 1], Y[p, 2], . . . , Y[p, NR]) of length NR on each range bin p. The FFT length K can be larger or smaller than NR, and is configurable by the radar application. If the FFT length K is smaller than NR, then only the first K-sample vector (Y[p, 1], . . . , Y[p, K]) will be considered for processing. If K is larger than NR, then K−NR zeros are added to (Y[p, 1], Y[p, 2], . . . , Y[p, NR]) prior to a K-point FFT operation.

FIG. 5 shows range-Doppler-angle domain sample generation from multi-channel range-Doppler sample streams including sample rearrangement 501, angle window coefficient buffer 502, angle window application 503, and angle FFT operation 504 according to the embodiments of our invention.

With NR antenna channels, the number of range-Doppler samples on antenna channel j is given by N*M where N is the number of range bins and M is the number of Doppler bins. With p denoting the range bin index, and q denoting the Doppler bin index, one complex-valued range-Doppler-antenna sample as input to sample rearrangement block 501 is given by X[p, q, j]. Block 501 rearranges N*M*NR samples into N*M range-Doppler channels, with NR samples per range-Doppler channel. One range-Doppler channel has NR samples. On each range-Doppler channel, a window of length NR coefficients is applied by 503 to a vector of samples of length NR. The window operation is elementwise. With Window(i) denoting the window coefficient i, i=1, . . . , NR, X[p, q, i] denoting the antenna sample index i on range-Doppler bin (p,q), the output of 503 is Y[p, q, i]=Window(i)*X[p, q, i]. Here, [Window(1), . . . , Window(NR)] is a coefficient vector that is common to all the range-Doppler bins and is stored in 502.

An FFT operation 504 is performed over a vector (Y[p, q, 1], Y[p, q, 2], . . . . , Y[p, q, NR]) of length NR on each range-Doppler bin (p,q). The FFT length can be larger or smaller than NR, and is configurable by the radar application. If the FFT length K is smaller than NR, then only the first K-sample vector (Y[p, q, 1], . . . , Y[p, q, K]) will be considered for processing. If K is larger than NR, then K−NR zeros are added to (Y[p, q, 1], Y[p, q, 2], . . . , Y[p, q, NR]) prior to a K-point FFT operation.

FIG. 6 shows detection metric and confidence computation for each range bin including range bin sample transformation 601, element-wise sample addition 602, sample assignment to bins 603, joint detection 604, and weight manager 604A according to the embodiments of our invention.

The range samples on channel j are given by a vector of N samples (X[1, j], X[2, j], . . . , X[N, j]), where j=1, . . . , NR, N is the number of range samples, and X[n, j] is the value in range bin n and on channel j. Each sample X[n, j] goes through a transform 601 to produce Y[n, j]=Phi(X[n, j]), where X[n, j] is complex-valued, Y[n, j] is real-valued, and example configurations of transform Phi(x) include Phi(x)=|x|, where |x| is the modulus of a complex-number x, Phi(x)=|x|\hat{ }2, and Phi(x)=log(|x|).

Element-wise addition 602 processes Y[n, j], n=1, . . . , N and j=1, . . . , NR, to produce Z[n]=sum(j=1, 2, . . . , NR){Y[n, j]}. Value Z[n] is assigned to Bin n in 603, for n=1, 2, . . . , N.

Joint detector 604 processes a vector of N samples (Z[1], Z[2], . . . , Z[N]) to produce confidence levels and detection metrics for each of the N bins. To process N range bins, 604 is configured by 604A with a matrix of N*N=N\hat{ }2 weights [W(1,1), . . . , W(1,N), W(2,1), . . . , W(2,N), . . . , W(N,1), . . . , W(N,N)] with a constraint that W(n, n)=0 for n=1, . . . , N.

For bin n, an estimate of the signal power is denoted by Sig[n] and an estimate of interface plus noise power is denoted as IpN[n]. The quantity Sig[n] is estimated as Sig[n]=C1*abs(Z[n]) and the quantity IpN[n] is estimated as IpN[n]=C2*abs(sum(k=1, 2, . . . , N){W(n, k)*Z[k]}), where C1 and C2 are two positive constants that are configured to be used with the joint detection algorithm. An estimate of the signal-to-noise ratio (SNR) is given by SNR[n]=Sig[n]/IpN[n]. The quantities Sig[n], IpN[n] and SNR[n] are the detection metrics corresponding to range bin n.

Making use of Sig[n] and IpN[n], 604 forms a metric T[n]=Sig[n]−IpN[n], for n=1, 2, . . . , N. The mean absolute value of T[1], . . . , T[N] is denoted by TBar and is computed as TBar=(1/N)*sum(n=1, . . . , N){abs(T[n])}. From T[1], . . . , T[N], and TBar, normalized metrics are computed as NormT[n]=T[n]/TBar, n=1, . . . , N.

The confidence metric for bin n is given by 100*exp(NormT[n])/(1+exp(NormT[n])). When NormT[n] takes a value above 5, confidence metric for bin n becomes 100 whereas when NormT[n] takes a value below −5, confidence metric for bin n becomes 0. Look-up tables can be used instead of explicitly computing the exponentials to arrive at confidence levels from 0 percent to 100 percent.

FIG. 7 shows detection metric and confidence level computation for each range-Doppler bin including range-Doppler bin sample transformation 701, element-wise sample addition 702, sample assignment to bins 703, joint detection 704, and weight manager 704A according to the embodiments of our invention.

The range-Doppler samples on channel j are given by a matrix of N-by-M samples whose (p, q) value is given by X[p, q, j], with p=1, . . . , N, q=1, . . . , M, and j=1, . . . , NR. Here, N is the number of range-domain samples, M is the number of Doppler-domain samples, and X[p, q, j] is the value in range bin p, Doppler bin q, and on channel j. Each sample X[p, q, j] goes through a transform 701 to produce Y[p, q, j]=Phi(X[p, q, j]), where X[p, q, j] is complex-valued, Y[p, q, j] is real-valued, and example configurations of Phi(x) include Phi(x)=|x|, Phi(x)=|x|\hat{ }2, and Phi(x)=log(|x|).

Element-wise addition 702 processes Y[p, q, j], p=1, . . . , N, q=1, . . . , M, and j=1, . . . , NR, to produce Z[p, q]=sum(j=1, 2, . . . , NR){Y[p, q, j]}. Value Z[p, q] is assigned to Bin [p, q] in 703.

Joint detector 704 processes a matrix of N*M samples (Z[1, 1], . . . , Z[N, M]) to produce confidence levels and detection metrics for each of the N*M range-Doppler bins. To process a range-Doppler bin indexed by p and q, 704 is configured by 704A with a matrix of N*M weights [W(1, 1, p, q), . . . , W(1, M, p, q), W(2, 1, p, q), . . . , W(2, M, p, q), . . . , W(N, 1, p, q), . . . , W(N, M, p, q)] with a constraint that W(i, j, p, q)=0 when i is equal to p and j is equal to q.

For range-Doppler bin indexed by p and q, an estimate of the signal power is denoted by Sig[p, q] and an estimate of interface plus noise power is denoted as IpN[p, q]. The quantity Sig[p, q] is estimated as Sig[p, q]=C1*abs(Z[p, q]) and the quantity IpN[p, q] is estimated as IpN[p, q]=C2*abs(sum(i=1, 2, . . . , N, j=1, 2, . . . , M){W(i, j, p, q)*Z[i, j]}), where C1 and C2 are two positive constants that are configured to be used with the joint detection algorithm. An estimate of the SNR on range-Doppler bin (p, q) is given by SNR[p, q]=Sig[p, q]/IpN[p, q]. The quantities Sig[p, q], IpN[p, q] and SNR[p, q] are the detection metrics corresponding to range-Doppler bin (p, q).

Making use of Sig[p, q] and IpN[p, q], 704 forms a metric T[p, q]=Sig[p, q]−IpN[p, q], for p=1, . . . , N and q=1, 2, . . . , M. The mean absolute value of T[1, 1], T[1, 2], . . . , T[N, M] is denoted by TBar and is computed as TBar=(1/N)*(1/M)sum(p=1, 2, . . . , N, q=1, 2, . . . , M){abs(T[p, q])}.

From T[p, q] and TBar, normalized metrics are computed as NormT[p, q]=T[p, q]/TBar, for p=1, 2, . . . , N and q=1, 2, . . . , M.

The confidence metric for bin (p, q) is given by 100*exp(NormT[p, q])/(1+exp(NormT[p, q])). When NormT[p, q] takes a value above 5, confidence metric for bin (p, q) becomes 100 whereas when NormT[p, q] takes a value below −5, confidence metric for bin (p, q) becomes 0. Look-up tables can be used instead of explicitly computing the exponentials to arrive at confidence levels from 0 percent to 100 percent.

FIG. 8 shows detection metric and confidence computation for each range-angle channel including range-angle channel sample transformation 801, sample rearrangement 802, sample assignment to bins 803, joint detection 804, and weight manager 804A according to the embodiments of our invention.

The range-angle samples on channel j are given by a vector of K samples whose k-th value is given by X[k, j], with k=1, . . . , K and j=1, . . . , N. Here, N is the number of range bins samples, K is the number of angle bins, and X[k, j] is the sample value in angle bin k and range bin j. Each sample X[k, j] goes through a transform 801 to produce Y[k, j]=Phi(X[k, j]), where X[k, j] is complex-valued, Y[k, j] is real-valued, and example configurations of Phi(x) include Phi(x)=|x|, Phi(x)=|x|\hat{ }2, and Phi(x)=log(|x|).

Upon sample arrangement 802, sample value Y[k, j] is assigned to Bin [k, j] in 803.

Joint detector 804 processes a matrix of N*K samples (Y[1,1], . . . , Y[K,N]) to produce confidence levels and detection metrics for each of the N*K range-angle bins. To process a range-angle bin indexed by k and n, 804 is configured by 804A with a matrix of N*K weights [W(1, 1, k, n), . . . , W(1, N, k, n), W(2, 1, k, n), . . . , W(2, N, k, n), . . . , W(K, 1, k, n), . . . , W(K, N, k, n)] with a constraint that W(i, j, k, n)=0 when i is equal to k and j is equal to n.

For a range-angle bin indexed by k and n, an estimate of the signal power is denoted by Sig[k, n] and an estimate of interface plus noise power is denoted as IpN[k, n]. The quantity Sig[k, n] is estimated as Sig[k, n]=C1*abs(Y[k, n]) and the quantity IpN[k, n] is estimated as IpN[k, n]=C2*abs(sum(i=1, 2, . . . , K, j=1, 2, . . . , N){W(i, j, k, n)*Y[i, j]}), where C1 and C2 are two positive constants that are configured to be used with the joint detection algorithm. An estimate of the SNR on range-angle bin (k, n) is given by SNR[k, n]=Sig[k, n]/IpN[k, n].

The quantities Sig[k, n], IpN[k, n] and SNR[k, n] are the detection metrics corresponding to range-angle bin (k, n).

Making use of Sig[k, n] and IpN[k, n], 804 forms a metric T[k, n]=Sig[k, n]−IpN[k, n], for k=1, . . . , K and n=1, 2, . . . , N. The mean absolute value of T[1, 1], T[1, 2], . . . , T[K, N] is denoted by TBar and is computed as TBar=(1/N)*(1/K)sum(k=1, 2, . . . , K, n=1, 2, . . . , N){abs(T[k, n])}.

From T[k, n] and TBar, normalized metrics are computed as NormT[k, n]=T[k, n]/TBar, for k=1, 2, . . . , K and n=1, 2, . . . , N.

The confidence metric for range-angle bin (k, n) is given by 100*exp(NormT[k, n])/(1+exp(NormT[k, n])). When NormT[k, n] takes a value above 5, confidence metric for bin (k,n) becomes 100 whereas when NormT[k, n] takes a value below −5, confidence metric for bin (k,n) becomes 0. Look-up tables can be used instead of explicitly computing the exponentials to arrive at confidence levels from 0 percent to 100 percent.

FIG. 9 shows detection metric and confidence computation for each range-Doppler-angle channel including range-Doppler-angle channel sample transformation 901, sample rearrangement 902, sample assignment to bins 903, joint detection 904, and weight manager 904A according to the embodiments of our invention.

With N range bins and M Doppler bins, there are N*M range-Doppler bins. In each range-Doppler bin, there are K samples after angular FFT processing. These N*M*K samples are organized into K range-Doppler-angle samples per range-Doppler channel [p, q] with p=1, 2, . . . , N and q=1, 2, . . . , M. We denote by X[k, i, j] a complex-valued sample belonging to angle bin k, range bin i, and Doppler bin j.

Each sample X[k, i, j] goes through a transform 901 to produce Y[k, i, j]=Phi(X[k, i, j]), where X[k, i, j] is complex-valued, Y[k, i, j] is real-valued, and example configurations of Phi(x) include Phi(x)=|x|, Phi(x)=|x|\hat{ }2, and Phi(x)=log(|x|).

Upon sample arrangement 902, sample value Y[k, i, j] is assigned to Bin [i, j, k] in 903.

Joint detector 904 processes a three-dimensional matrix of N*M*K samples (Y[1, 1, 1], . . . , Y[N, M, K]) to produce confidence levels and detection metrics for each of the N*M*K range-Doppler-angle bins. To process a range-Doppler-angle bin indexed by (i, j, k), 904 is configured by 904A with a three-dimensional matrix of N*M*K weights [W(1, 1, 1, i, j, k), . . . , W(1, M, 1, i, j, k), W(2, 1, 1, i, j, k), . . . , W(2, M, 1, i, j, k), . . . , W(N, M, 1, i, j, k), . . . , W(N, M, K, i, j, k)] with a constraint that W(p, q, r, i, j, k)=0 when p is equal to i, q is equal to j, and r is equal to k.

For range-Doppler-angle bin indexed by (i, j, k), an estimate of the signal power is denoted by Sig[i, j, k] and an estimate of interface plus noise power is denoted as IpN[i, j, k]. The quantity Sig[i, j, k] is estimated as Sig[i, j, k]=C1*abs(Y[i, j, k]) and the quantity IpN[i, j, k] is estimated as IpN[i, j, k]=C2*abs(sum(p=1, 2, . . . , N, q=1, 2, . . . , M, r=1, 2, . . . , K){W(p, q, r, i, j, k)*Y[p, q, r]}), where C1 and C2 are two positive constants that are configured to be used with the joint detection algorithm. An estimate of the SNR on range-Doppler-angle bin (i, j, k) is given by SNR[i, j, k]=Sig[i, j, k]/IpN[i, j, k]. The quantities Sig[i, j, k], IpN[i, j, k] and SNR[i, j, k] are the detection metrics corresponding to range-Doppler-angle bin (i, j, k).

Making use of Sig[i, j, k] and IpN[i, j, k], 904 forms a metric T[i, j, k]=Sig[i, j, k]−IpN[i, j, k], for i=1, 2, . . . , N, j=1, 2, . . . , M, and k=1, 2, . . . , K. The mean absolute value of T[1, 1, 1], T[1, 2, 1], . . . , T[N, M, K] is denoted by TBar and is computed as TBar=(1/N)*(1/M)*(1/K)sum(i=1, 2, . . . , N, j=1, 2, . . . , M, k=1, 2, . . . , K){abs(T[i, j, k])}.

From T[i, j, k] and TBar, normalized metrics are computed as NormT[i, j, k]=T[i, j, k]/TBar, for i=1, 2, . . . , N, j=1, 2, . . . , M, and k=1, 2, . . . , K.

The confidence metric for range-Doppler-angle bin (i, j, k) is given by 100*exp(NormT[i, j, k])/(1+exp(NormT[i, j, k])). When NormT[i, j, k] takes a value above 5, confidence metric for bin (i, j, k) becomes 100 whereas when NormT[i, j, k] takes a value below −5, confidence metric for bin (i, j, k) becomes 0. Look-up tables can be used instead of explicitly computing the exponentials to arrive at confidence levels from 0 percent to 100 percent.

FIG. 10 shows confidence metric computation for a group of samples including a weight manager 1001A, an affine transform 1001, element-wise nonlinear transform 1002, an affine transform 1003, element-wise nonlinear transform 1004, an affine transform 1005, and element-wise nonlinear transform 1006 according to the embodiments of our invention.

A P-dimensional input vector s is given by s=(s[1], s[2], . . . , s[P]). An example of input vector s is de-compressed real- and imaginary-parts of ADC samples received over NR antenna channels, NP pulses and NS samples per pulse with P=2*NR*NP*NS.

Using the weights F1 and b1 from 1001A, the affine transform block 1001 processes s to produce a Q1-dimensional vector x as x=F1*s+b1, where x=(x[1], x[2], . . . , x[Q1]), F1 is a real-valued matrix of size Q1-by-P, and b1 is a real-valued vector of size Q1-by-1. Each element of x is sent to a nonlinear transform operator 1002 to produce y[j]=Sigma(x[j]), j=1, . . . , Q1, where Sigma(·) is a nonlinear function. Example nonlinear mappings include Sigma(x)=exp(x)/(1+exp(x)), Sigma(x)=max(x,0), Sigma(x)=|x|, Sigma(x)=x*x, and Sigma(x)=(exp(x)−exp(−x))/(exp(x)+exp(−x)).

Using the weights F2 and b2 from 1001A, the affine transform block 1003 processes y to produce a Q2-dimensional vector z as z=F2*y+b2, where z=(z[1], z[2], . . . , z[Q2]), F2 is a real-valued matrix of size Q2-by-Q1, and b2 is a real-valued vector of size Q2-by-1. Each element of z is sent to a nonlinear transform operator 1004 to produce u[j]=Mu(z[j]), j=1, . . . , Q2, where Mu(·) is a nonlinear function. Example nonlinear mappings include Mu(x)=exp(x)/(1+exp(x)), Mu(x)=max(x,0), Mu(x)=|x|, Mu(x)=x*x, and Mu(x)=(exp(x)−exp(−x))/(exp(x)+exp(−x)).

Using the weights F3 and b3 from 1001A, the affine transform block 1005 processes u to produce a Q-dimensional vector v as v=F3*u+b3, where v=(v[1], v[2], . . . , v[Q]), F3 is a real-valued matrix of size Q-by-Q2, and b3 is a real-valued vector of size Q-by-1. Each element of v is sent to a nonlinear transform operator 1006 to produce a confidence value y[j]=Lambda(v[j]), j=1, . . . , Q, where Lambda(x)=100*exp(x)/(1+exp(x)).

When v[j] takes a value above 5, confidence metric for y[j] becomes 100 whereas when v[j] takes a value below −5, confidence metric for y[j] becomes 0. Look-up tables can be used instead of explicitly computing the exponentials to arrive at confidence levels from 0 percent to 100 percent.

The number of bins Q is chosen based on the number of ADC channels NR, number of samples per pulse NS, and number of pulses NP. When NR=1 and NP=1, the number of range bins is assigned to Q. When NR=1 and NP is greater than 1, the number of range-Doppler bins is assigned to Q. When NP=1 and NR is greater than 1, the number of range-angle bins is assigned to Q. When NP is greater than 1 and NR is greater than 1, the number of range-Doppler-angle bins is assigned to Q.

### BRIEF DESCRIPTION OF DRAWINGS

FIG. 1 is a block diagram of calibration compensation using compressed samples according to embodiments of the invention.

FIG. 2 is a block diagram of range-domain sample generation from time-domain samples according to embodiments of the invention.

FIG. 3 is a block diagram of range-Doppler sample generation from range-domain samples according to embodiments of the invention.

FIG. 4 is a block diagram of range-angle sample generation from range-domain samples according to embodiments of the invention.

FIG. 5 is a block diagram of range-Doppler-angle sample generation from range-Doppler samples according to embodiments of the invention.

FIG. 6 is a block diagram of confidence-level based object detection from range-domain samples according to embodiments of the invention.

FIG. 7 is a block diagram of confidence-level based object detection from range-Doppler samples according to embodiments of the invention.

FIG. 8 is a block diagram of confidence-level based object detection from range-angle samples according to embodiments of the invention.

FIG. 9 is a block diagram of confidence-level based object detection from range-Doppler-angle samples according to embodiments of the invention.

FIG. 10 is a block diagram of confidence-level generation from time-domain samples according to embodiments of the invention.

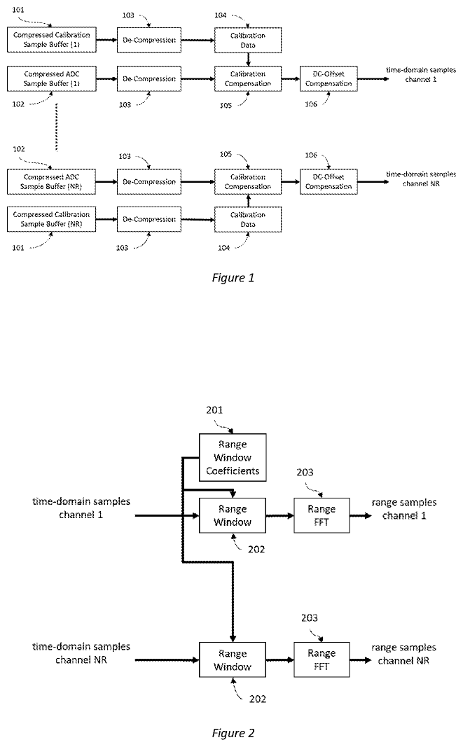

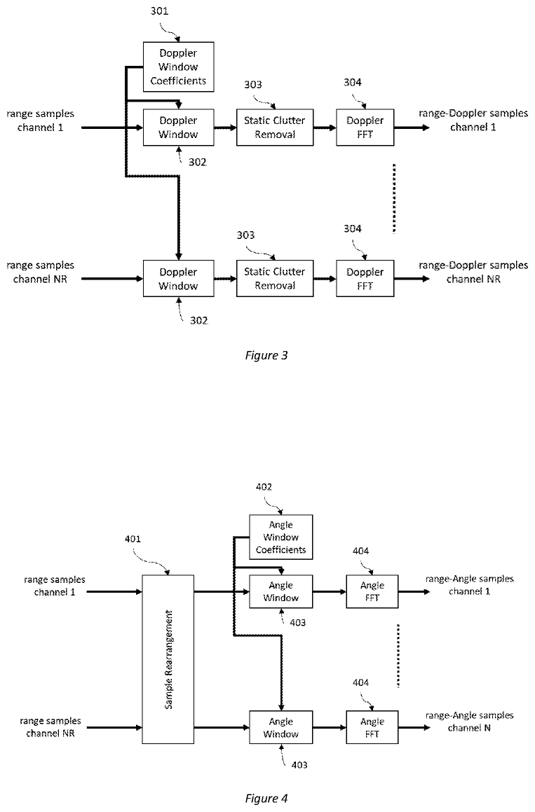

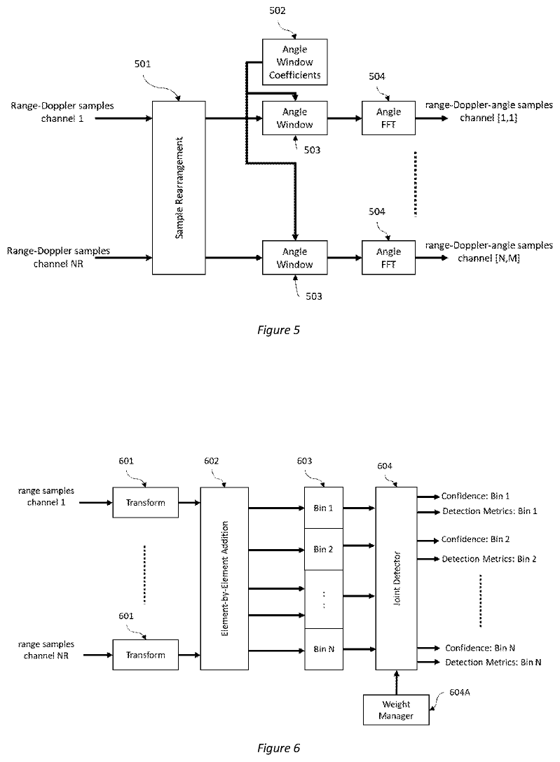

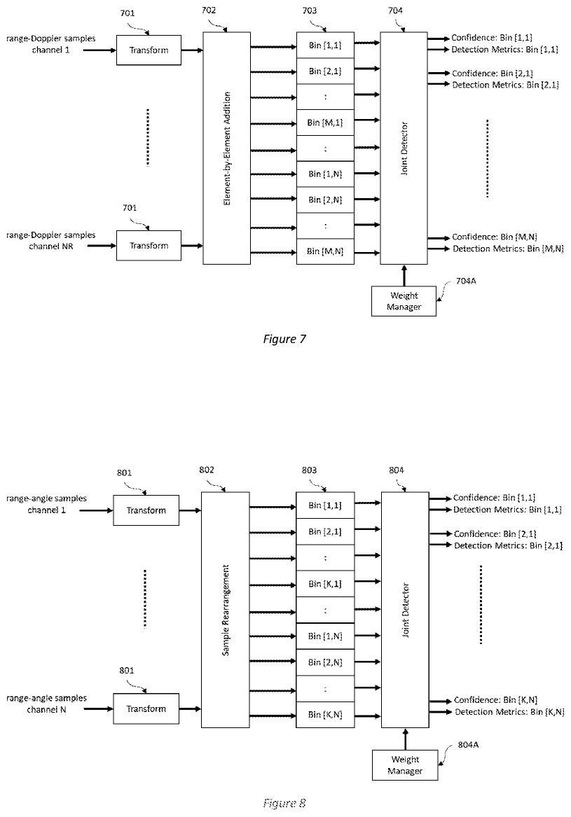

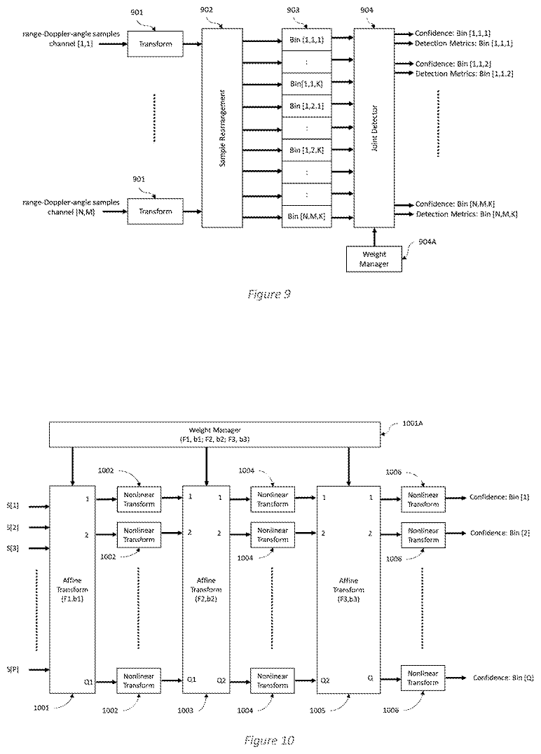

1. A method for detecting a plurality of objects using multi-channel compressed radar ADC data.

2. The method of claim 1, wherein object detection is performed on samples after de-compression of compressed radar ADC data.

3. The method of claim 1, wherein object detection is performed on samples after range FFT operation.

4. The method of claim 1, wherein object detection is performed on samples after range and Doppler FFT operations.

5. The method of claim 1, wherein object detection is performed on samples after range and angle FFT operations.

6. The method of claim 1, wherein object detection is performed on samples after range, Doppler, and angle FFT operations.

7. A method for generation of confidence levels using multi-channel compressed radar ADC data.

8. The method of claim 7, wherein confidence levels are generated by processing samples after de-compression of compressed radar ADC data.

9. The method of claim 7, wherein confidence levels are generated by processing samples after range FFT operation.

10. The method of claim 7, wherein confidence levels are generated by processing samples after range and Doppler FFT operations.

11. The method of claim 7, wherein confidence levels are generated by processing samples after range and angle FFT operations.

12. The method of claim 7, wherein confidence levels are generated by processing samples after range, Doppler, and angle FFT operations.
